(19) United States
(12) Patent Application Publication
(10) Pub. No.: US 2007/0229663 A1
(43) Pub. Date: Oct. 4, 2007

(54) Image processing apparatus, monitoring camera, and image monitoring system

(75) Inventors: Teruma Aoto, Tokyo (JP); Kenji Fujino, Tokyo (JP); Ryousuke Kashiwa, Tokyo (JP); Kazurou Itou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 11/727,082

(22) Filed: Mar. 23, 2007

(30) Foreign Application Priority Data
Mar. 31, 2006 (JP) 2006-096195

(51) Int. Cl. H04N 7/18

(52) U.S. Cl. 348/155

(57) ABSTRACT

An image processing apparatus, a monitoring camera, and an image monitoring system are provide which are capable of eliminating false reports made in a motion analysis process to provide more advanced behavior analysis. The image processing apparatus includes: a motion analysis unit which receives a moving image on a monitoring area captured by an external monitoring camera, analyzes a general purpose motion of a person appearing on the monitoring area by performing a predetermined image analysis process to the moving image, and outputs time-series data related to the general purpose motion of the person; and a motion identification unit which identifies, on the basis of the time-series data related to the general purpose motion of the person, whether or not the general purpose motion corresponds to a specific purpose motion that satisfies a predetermined condition, and outputs motion identification information representing the identification result.

### BACKGROUND OF THE INVENTION

1. Field of the Invention

The present invention relates to an image processing apparatus, a monitoring camera, and an image monitoring system.

Priority is claimed on Japanese Patent Application JP 2006-096195, filed on Mar. 31, 2006, the contents of which are incorporated herein by reference.

2. Description of Related Art

Japanese Unexamined Patent Application, First Publication No. H09-330415 discloses an image monitoring system in which a moving image on a monitoring area captured by a television camera is subjected to a predetermined image analysis process so as to extract a movement locus of a person, and a determination processing mode, which is an algorithm for determining whether or not the person is an intruder on the basis of the movement locus, is switched in accordance with a monitoring condition. Since the person's behavior around an entrance of a store may differ from time to time, for example, the opening and closing time of the store, it is necessary to change the determination processing mode even in the same monitoring area depending on the time zone or the season. However, since the determination processing mode is unchangeable in conventional image monitoring systems, there is a problem in that a plurality of image processing apparatuses need to be installed to cope with differing monitoring subjects and purposes, which thereby increases the total system cost and complicates security management. The technology disclosed in Japanese Unexamined Patent Application, First Publication No. H09-330415 has been made in view of these problems.

As another example of the image monitoring technology, Japanese Unexamined Patent Application, First Publication No. 2001-175868 discloses a human detection apparatus in which a feature quantity of a person is detected from a moving image captured on a monitoring area on which a number of persons appear and move, and it is determined whether or not the feature quantity satisfies a predetermined human shape model, thereby determining the presence of the person and the number of the person.

As a further example of the image monitoring technology, Japanese Unexamined Patent Application, First Publication No. 2000-149025 discloses a gesture recognition apparatus which measures three-dimensional coordinates of a feature point set of a person's body such as hands or legs, thereby recognizing the person's gesture (motions).

Upon recognizing the human's gesture, a predetermined gesture analysis process is performed on the basis of a moving image captured on a monitoring area and a gesture analysis parameter, and information related to the gesture is output. For example, information such as the type (walk or bend) or occurrence time of the gesture or the position of the person is output as the information related to the gesture.

However, the above-described conventional image monitoring technology for recognizing a person's gesture has the following problems:

(1) It is only possible to recognize momentary gesture that is obtained from the movement of the person or the amount of variation in the person's physical characteristics;

(2) It is only possible to reduce false detection through adjustment of the gesture analysis parameter;

(3) It needs to adjust respective gesture analysis parameters for the entire gestures obtained in different capturing environments (for example, the capturing location), which thereby makes the gesture detection unstable; and

(4) It needs to change the system itself when the purpose of use changes.

### SUMMARY OF THE INVENTION

The present invention has been made in view of the above-described situations, and its object is to provide an image processing apparatus, a monitoring camera, and an image monitoring system, which can alleviate the above-described problems. More specifically, the present invention aims to provide an image processing apparatus, a monitoring camera, and an image monitoring system, capable of eliminating false detection made in a motion analysis process for a person to provide more accurate behavior analysis, generating a new motion (for example, information obtained on the basis of a plurality of motions) by using the motion analysis result, coping up with changes in the monitoring system's purpose of use only with a simple change in settings, and generating and changing motions in accordance with the system's environment and purpose of use.

In order to achieve the foregoing object, an image processing apparatus according to a first aspect of the present invention comprises: a motion analysis unit which receives a moving image on a monitoring area captured by an external monitoring camera, analyzes general purpose motion of a person appearing on the monitoring area by performing a predetermined image analysis process on the moving image, and outputs time-series data related to the general purpose motion of the person; and a motion identification unit which identifies, on the basis of the time-series data related to the general purpose motion of the person, whether or not the general purpose motion corresponds to a specific purpose motion that satisfies a predetermined condition, and outputs motion identification information representing the identification result.

In the image processing apparatus according to the first aspect of the present invention, the motion analysis unit may include a first storage unit for storing a motion analysis parameter used for analyzing the general purpose motion of the person, the motion analysis unit analyzing the general purpose motion of the person appearing on the monitoring area on the basis of the motion analysis parameter stored in the first storage unit and the moving image received from the monitoring camera, and wherein the motion identification unit may include a second storage unit for storing a motion identification parameter used for identifying whether or not the general purpose motion corresponds to the specific purpose motion that satisfies the predetermined condition, the motion identification unit identifying whether or not the general purpose motion corresponds to the specific purpose motion that satisfies the predetermined condition, on the basis of the motion identification parameter stored in the second storage unit and the time-series data related to the general purpose motion of the person.

In the image processing apparatus according to the first aspect of the present invention, the motion analysis unit may correlate the position of the person, the type of the general purpose motion, and the occurrence time of the general purpose motion with image data including still images of a predetermined number of frames acquired from the moving image and may output correlated data as the time-series data related to the general purpose motion of the person, and the motion identification unit may output the type, duration, and danger level of the specific purpose motion, as the motion identification information.

In the image processing apparatus according to the first aspect of the present invention, the motion identification unit may identify whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

An image processing apparatus according to a second aspect of the present invention comprises: a motion identification unit which identifies, on the basis of time-series data related to a general purpose motion of a person appearing on a predetermined monitoring area, the time-series data being received from the outside, whether or not the general purpose motion corresponds to a specific purpose motion that satisfies a predetermined condition, and outputs motion identification information representing the identification result.

In the image processing apparatus according to the second aspect of the present invention, the motion identification unit may identify whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

A monitoring camera according to the present invention comprises: an image capturing unit which captures a moving image on a predetermined monitoring area; and a motion analysis unit which analyzes a general purpose motion of a person appearing on the monitoring area by performing a predetermined image analysis process to the moving image and outputs time-series data related to the general purpose motion of the person.

An image monitoring system according to a first aspect of the present invention comprises: a monitoring camera which captures a moving image on a predetermined monitoring area; an image processing apparatus including: a motion analysis unit which receives the moving image on the monitoring area captured by the monitoring camera, analyzes general purpose motion of a person appearing on the monitoring area by performing a predetermined image analysis process on the moving image, and outputs time-series data related to the general purpose motion of the person; and a motion identification unit which identifies, on the basis of the time-series data related to the general purpose motion of the person, whether or not the general purpose motion corresponds to a specific purpose motion that satisfies a predetermined condition, and outputs motion identification information representing the identification result; and an informing unit which signals the motion identification information output from the image processing apparatus.

In the image monitoring system according to the first aspect of the present invention, the motion analysis unit may include a first storage unit for storing a motion analysis parameter used for analyzing the general purpose motion of the person, the motion analysis unit analyzing the general purpose motion of the person appearing on the monitoring area on the basis of the motion analysis parameter stored in the first storage unit and the moving image received from the monitoring camera, and the motion identification unit may include a second storage unit for storing a motion identification parameter used for identifying whether or not the general purpose motion corresponds to the specific purpose motion that satisfies the predetermined condition, the motion identification unit identifying whether or not the general purpose motion corresponds to the specific purpose motion that satisfies the predetermined condition, on the basis of the motion identification parameter stored in the second storage unit and the time-series data related to the general purpose motion of the person.

In the image monitoring system according to the first aspect of the present invention, the motion analysis unit may correlate the position of the person, the type of the general purpose motion, and the occurrence time of the general purpose motion with image data including still images of a predetermined number of frames acquired from the moving image and may output correlated data as the time-series data related to the general purpose motion of the person, and the motion identification unit may output the type, duration, and danger level of the specific purpose motion, as the motion identification information.

In the image monitoring system according to the first aspect of the present invention, the motion identification unit may identify whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

An image monitoring system according to a second aspect of the present invention comprises: a monitoring camera which includes: an image capturing unit capturing a moving image on a predetermined monitoring area; and a motion analysis unit analyzing general purpose motion of a person appearing on the monitoring area by performing a predetermined image analysis process on the moving image and outputting time-series data related to the general purpose motion of the person; an image processing apparatus which includes a motion identification unit identifying, on the basis of the time-series data related to the general purpose motion of the person appearing on the predetermined monitoring area, whether or not the general purpose motion corresponds to a specific purpose motion that satisfies a predetermined condition, and outputting motion identification information representing the identification result; and an informing unit which signals the motion identification information output from the image processing apparatus.

In the image monitoring system according to the second aspect of the present invention, the motion identification unit may identify whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

According to the present invention, an image processing apparatus is provided which detects the motion of a person appearing on a monitoring area on the basis of a moving image on the monitoring area captured and received from an external monitoring camera. The image processing apparatus includes a motion analysis unit for analyzing general purpose motion and a motion identification unit for identifying a specific purpose motion that satisfies a predetermined condition. That is, the operations of the image processing apparatus are divided into two steps, i.e., a general purpose motion analysis step and a specific purpose motion identification step. Accordingly, it is possible to eliminate false detection made in the motion analysis unit to provide more advanced behavior analysis. Moreover, it is possible to generate new motion using the result of the general purpose motion analysis made in the motion analysis unit. In addition, it is possible to flexibly cope with changes in the system's purpose of use by simply changing the settings of the motion identification parameter used in the motion identification unit for identifying the specific purpose motion. In other words, it is possible to generate and change desired motion in accordance with the system's environment and purpose of use.

### BRIEF DESCRIPTION OF THE DRAWINGS

FIG. 1 is a block diagram showing the arrangement of an image monitoring system in accordance with an embodiment of the present invention.

FIG. 2 is a flowchart for explaining a motion analysis process of a motion analysis device 201 shown in FIG. 1.

FIG. 3 is a flowchart for explaining a motion identification process of a motion identification device 202 shown in FIG. 1.

FIG. 4 is a schematic diagram for explaining a first example of a specific purpose motion identification method used in the motion identification device 202.

FIG. 5 is a schematic diagram for explaining a second example of a specific purpose motion identification method used in the motion identification device 202.

FIG. 6 is a block diagram showing a first modified example of the image monitoring system of the present invention.

FIG. 7 is a block diagram showing a second modified example of the image monitoring system of the present invention.

FIG. 8 is a block diagram showing a third modified example of the image monitoring system of the present invention.

FIG. 9 is a block diagram showing a fourth modified example of the image monitoring system of the present invention.

FIG. 10 is a block diagram showing a fifth modified example of the image monitoring system of the present invention.

### DETAILED DESCRIPTION OF THE INVENTION

Hereinafter, embodiments of the present invention will be described with reference to the accompanying drawings.

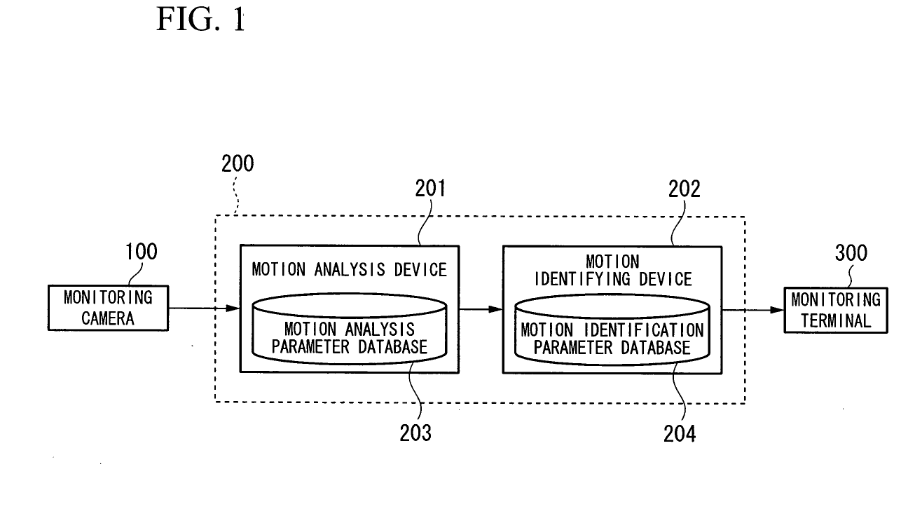

FIG. 1 is a block diagram showing the basic arrangement of an image monitoring system in accordance with an embodiment of the present invention. As shown in the drawing, the image monitoring system includes a monitoring camera 100, an image processing apparatus 200, and a monitoring terminal (an informing unit) 300. The image processing apparatus 200 includes a motion analysis device (a motion analysis unit) 201 and a motion identification device (a motion identification unit) 202. The input of the image processing device 200 is connected to the monitoring camera 100 and the output of the image processing device 200 is connected to the monitoring terminal 300 via a LAN (local area network) communication line.

The monitoring camera 100 may be a general purpose video monitoring camera which captures a moving image on a predetermined monitoring area and outputs the captured moving image as an image signal (a picture signal). The image signal may be a digital image signal obtained by encoding an analog video signal, for example, of a NTSC (National Television System Committee) format. The monitoring camera 100 may be installed, for example, on a platform area in a railway station, captures a digital image signal from a monitoring area of the platform in a real-time basis, and transmits the real-time image to the image processing apparatus 200 (specifically, to the motion analysis device 201).

In the image processing apparatus 200, the motion analysis device 201 includes a motion analysis parameter database (a first storage unit) 203 for storing therein a motion analysis parameter that is an analysis condition used for analyzing the general purpose motion of a person in advance, performs a predetermined image analysis process on the basis of a moving image captured by the monitoring camera 100 and the motion analysis parameter to analyze the general purpose motion of the person appearing on the monitoring area, and outputs time-series data related to the general purpose motion of the person to the motion identification device 202. The time-series data includes the general purpose motion information and the motion analysis information. The term “general purpose motion” used herein refers to a human's basic behavior that does not depend on the system's environment and purpose of use. An example of the general purpose motion may include motions such as walking or bending. These motions all represent a momentary situation. The general purpose motion information represents the type of the general purpose motions. Meanwhile, the motion analysis information may include the occurrence time or position of the general purpose motion and the movement direction of a person if the person is walking.

The motion identification device 202 includes a motion identification parameter database (a second storage unit) 204 for storing therein a motion identification parameter that is an identification condition for determining whether or not the general purpose motion detected by the motion analysis device 201 corresponds to a specific purpose motion that satisfies a predetermined condition, identifies the specific purpose motion on the basis of the time-series data related to the general purpose motion output from the motion analysis device 201 and the motion identification parameter, and outputs motion identification information representing the identification result to the monitoring terminal 300. The motion identification information may represent a type, for example, a sick person or a drunken person, duration, and danger level of the specific purpose motion.

The monitoring terminal 300 may be a computer terminal such as a personal computer, which is configured to include a main body having a central processing unit (CPU) and a storage unit, a display unit, a keyboard, a mouse, and the like and display (inform) the motion identification information on a predetermined display or the like.

The term “specific purpose motion” used herein refers to a human's behavior that depends on the system's environment and purpose of use and represents a motion that can be defined by a combination of the general purpose motion and the motion analysis information. For example, in an image monitoring system installed in a railway station, when a person is bending on a platform for a long time, this can be identified as a motion indicative of being sick, but it may be identified as a normal motion if the person is in an ordinary household. If the person is not on a platform or the passage of a railway station but a place such as a resting area or a place in the vicinity of the outlet of a vending machine installed on the platform, the event where the person is bending for a predetermined time is identified as a normal motion. Here, it is possible to be defined that the specific purpose motion indicative of being sick is identified by a combination of the general purpose motions, i.e., bending and the occurrence time (duration) of the motion analysis information.

The parameters stored in the motion identification parameter database 204 include the following: a parameter “WINDOWSIZE” representing the range of data used in the identification (how many seconds of data will be verified); a parameter “CONTINUOUS” representing the number of continuous occurrences of a motion serving as an identification condition; a parameter “MISS” representing the number of allowable lost reports of a motion; a parameter “SEC_OR_FRAME” representing whether the number of continuous occurrences will be counted on the basis of “seconds” (in this case, the parameter is set to “0”) or “frames” (in this case, the parameter is set to “1”); a parameter “PN” representing whether a number for identifying respective persons appearing on the same frame of the image (hereinafter referred to as “a person number”) will be taken into account or not (the parameter is set to “1” when the person number is taken into account, or “0” when the person number is not taken into account); and a parameter “STOP_TIME” representing the number of seconds for which detection of an event is stopped if the event has been detected already. In particular, as an example of sub-parameters for identifying a person being sick from a person being bend, there is a sub-parameter “CONTINUOUS_H” representing a threshold value of duration for determining a person being sick and a sub-parameter “CONTINUOUS_L” representing a threshold value of duration for determining that a person is bending.

For example, in the case of determining that a person continues bending as the person being sick, the parameters are typically set to the following values: WINDOWSIZE=10; CONTINUOUS_H=7; CONTINUOUS_L=3; MISS=2; SEC_OR_FRAME=0; PN=0; and STOP_TIME=10. These parameter values represent the following case where: a continuous bending for 7 seconds detected through verification of data for 10 seconds is determined that a person is sick. In this case, however, when a person being bending is not detected after the identification of the person being sick and is detected within 2 seconds thereafter, it is still determined that the person is sick, whereas, when a person being bending is not detected for a period equal to or greater than 3 seconds after the identification of being sick, it is not determined that a person is sick any more. The person number is not taken into account; and the detection of a person being sick is stopped for 10 seconds if it has been detected already.

The motion identification information may be configured to represent the duration and danger level of the general purpose or specific purpose motion, in addition to the motion analysis information. When a motion indicative of being sick is identified, the motion identification information about the danger level is configured in such a manner that the danger level assigned to the case of the motion being detected at a nearby portion of the rail is higher than the case of the motion being detected at a central portion of the platform.

In the example shown in FIG. 1, the motion identification device 202 is connected to one motion analysis device 201 but may be connected to a plurality of motion analysis devices 201.

As described above, according to the motion identification device 202 shown in FIG. 1, it is possible to eliminate false reports and generate a new motion (specific purpose motion) by using the time-series data related to a general purpose motion output from the motion analysis device 201. Moreover, it is possible to cope with changes in the system's purpose of use by simply changing the settings of the motion identification device 202. For example, as to a person continuing bending for a predetermined time, the motion identification device 202 may regard it as a person being sick or the person being bending as it is, or may ignore it and output nothing. Since the general purpose motion corresponds to basic human behavior, it does not require any adjustment for a change in the system, thereby decreasing the number of processes required for the system adjustment.

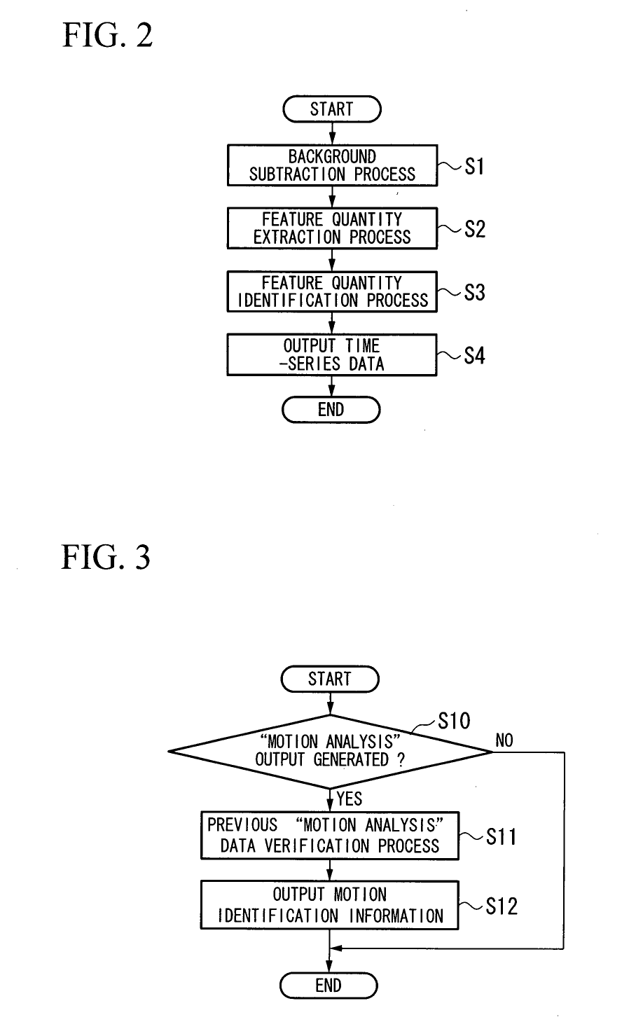

Next, a flowchart of the motion analysis process by the motion analysis device 201 shown in FIG. 1 will be described with reference to FIG. 2. The motion analysis device 201 extracts an object (a person) through a background subtraction process (step S1) and extracts a feature quantity of the extracted object through a feature quantity extraction process (step S2), by using a digital image signal on a monitoring area captured by the monitoring camera 100. For example, the feature quantity may be a contour, a color, a size, or the like. Next, the feature quantity extracted through the feature quantity extraction process is identified as a particular general purpose motion in accordance with a motion analysis parameter (various conditions or rules used for extracting a person's motion) stored in advance in the motion analysis parameter database 203 (step S3), and the time-series data related to the general purpose motion of the person is output to the motion identification device 202 (step S4). Here, the amount of data output in one second depends on the number of frames of image input in one second, the processing speed of the motion analysis device, and the total number of people.

By restricting the subject of the analysis only to the general purpose motion using the process described with reference to FIG. 2, it is possible to simplify the parameter adjustment required for the motion analysis. Moreover, since the general purpose motion analyzed in the motion analysis device 201 is verified again in the motion identification device 202, the motion analysis device 201 does not need to tightly perform the adjustment.

Next, a flowchart of a motion identification process by the motion identification device 202 shown in FIG. 1 will be described with reference to FIG. 3. The motion identification device 202 is operated only when it is determined in the determination process (step S10) that the time-series data related to the general purpose motion is output through the motion analysis process described in FIG. 2. When it is determined that the time-series data has been output, the time-series data related to the previous general purpose motion and the time-series data related to the present general purpose motion are verified through a previous motion analysis data verification process (step S11) in accordance with the time-series data related to the general purpose motion and the motion identification parameter, which is data representing an identification condition, stored in the motion identification parameter database 204. Then, motion identification information is generated through a motion identification result generation process (step S12) on the basis of the verification result and output the motion identification information to the monitoring terminal 300.

In the data verification process of step S11, based on the time-series data related to the general purpose motion, the continuity of a general purpose motion is determined, a relation of a general purpose motion with another general purpose motion is verified in consideration of the distance to the subject (person) or size of the subject (person), and a relation to a background such as a predetermined obstacle area is verified.

By verifying the previously accumulated data obtained as a result of the general purpose motion analysis using the process described with reference to FIG. 3, it is possible to analyze a scene in which the motion has occurred to enable identification of a complicated specific purpose motion. Moreover, it is possible to generate and change the output motions in accordance with the system's environment and purpose of use.

The output motions can be changed in accordance with the system's environment and purpose of use by simply changing the settings of the motion identification device. In addition, since the specific purpose motion is a combination of the general purpose motion and the motion analysis information, a further parameter adjustment due to the change in the environment is not required for the same specific purpose motions. For example, although a picture taken in the daytime and a picture taken at night may require different adjustments for extracting a person from the picture, it is unnecessary to change the identification definition that a person continuing bending for a long time is regarded as the person being sick.

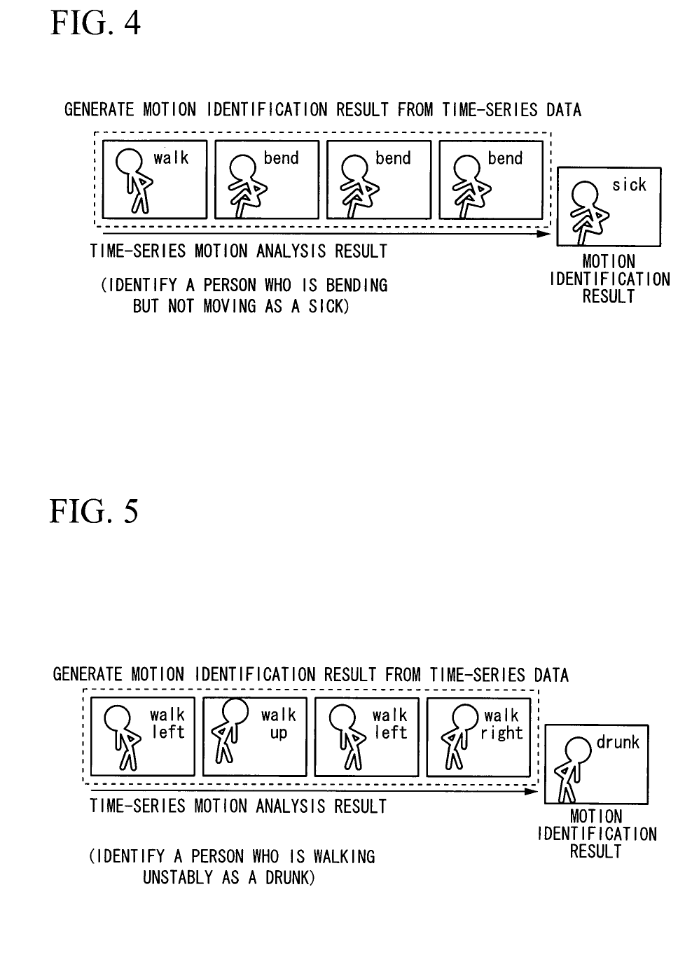

Next, an exemplary operation of the image monitoring system for identifying a person being sick through the motion analysis and motion identification processes will be described with reference to FIG. 4. In the example, the result of the time-series motion analysis shows that at first a person is walking, the person is then bending, and if the person continues bending, a continuous bending is identified as the person being sick. That is, a person who is bending and is not moving for a predetermined time is defined as being sick.

Next, an exemplary operation of the image monitoring system for identifying a person being drunk through motion analysis and motion identification processes will be described with reference to FIG. 5. In the example, the result of the time-series motion analysis shows that a person continues walking and the movement direction of the person is unstable, and the person is identified as being drunk.

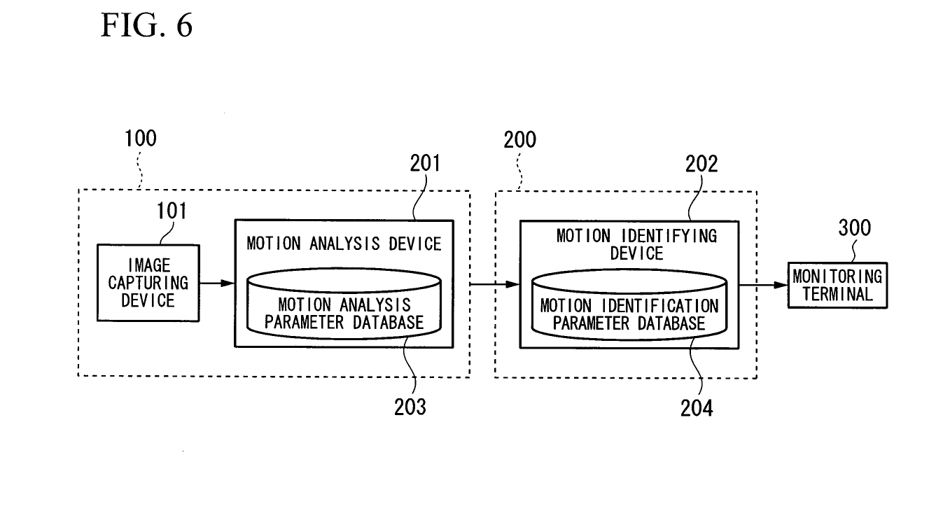

Next, a modified example of the image monitoring system will be described with reference to FIG. 6. In the arrangement shown in FIG. 6, the monitoring camera 100 includes a capturing device (a capturing unit) 101 capturing a moving image on a monitoring area and a motion analysis device 201 generating time-series data related to a general purpose motion on the basis of the moving image captured by the capturing device 101, and the image processing apparatus 200 is configured to have only the motion identification device 202. That is, both the monitoring camera 100 and the motion analysis device 201, shown in FIG. 1 are configured to have a hardware configuration. The term “hardware configuration” used herein refers to a configuration in which a control unit of devices such as input and output devices is operated by firmware. About 80% of the entire process, including image processing, is performed by the motion analysis device 201. Similarly, about 20% of the entire process is performed by the motion identification device 202. According to the arrangement shown in FIG. 6, by performing about 80% of the entire process with a hardware configuration, it is possible to reduce software burdens, thereby speeding up the entire system.

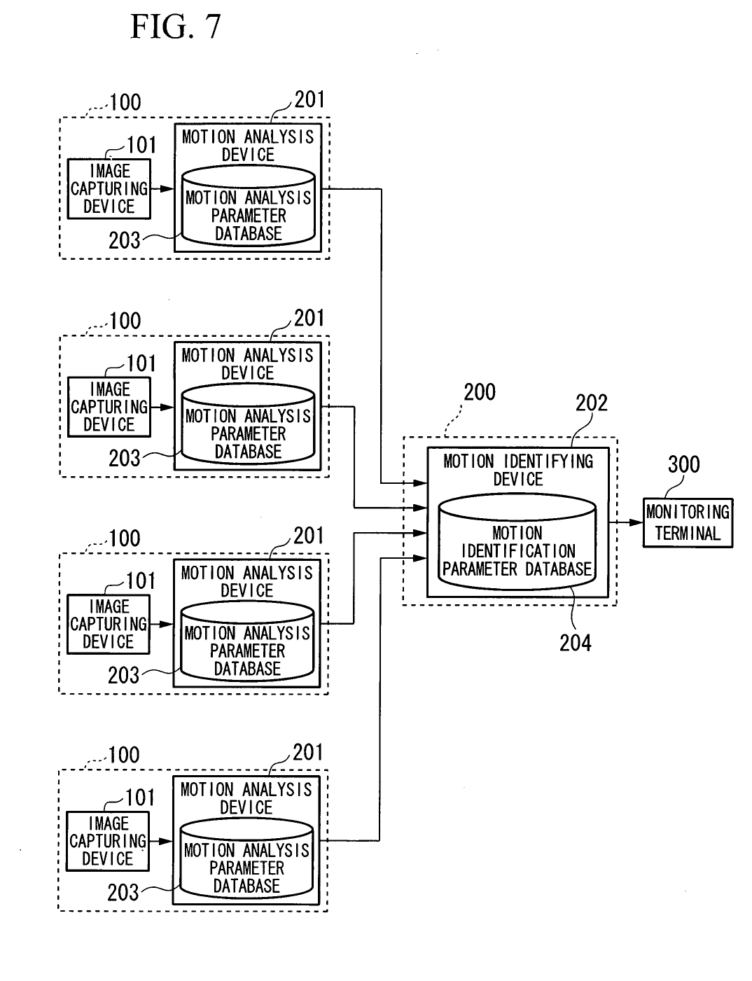

Next, an exemplary arrangement of the image monitoring system in which the motion analysis for a plurality of image inputs is combined with motion identification will be described with reference to FIG. 7. In the example shown in FIG. 7, the image monitoring system is configured to cope with a plurality of image inputs based on the system arrangement shown in FIG. 6. Since it is configured to perform the motion analysis process through a hardware configuration, the software processing of the motion identification device 202 takes a proportion of the entire process corresponding to 20%×the number of image input devices (monitoring cameras).

According to the arrangement in which four monitoring cameras 100 are connected to the image processing apparatus 200, as shown in FIG. 7, software processing takes 80% (=20%×4) of the entire process. Accordingly, it is possible to obtain a processing capability (processing speed) 5 times more than that (400%=100%×4) obtainable in the case where the motion analysis process is not performed through the hardware configuration. Moreover, considering distribution of the processing in the motion analysis and the motion identification, it is possible to cope with the plurality of image inputs through a processing equivalent to that applied to the case of a single image input.

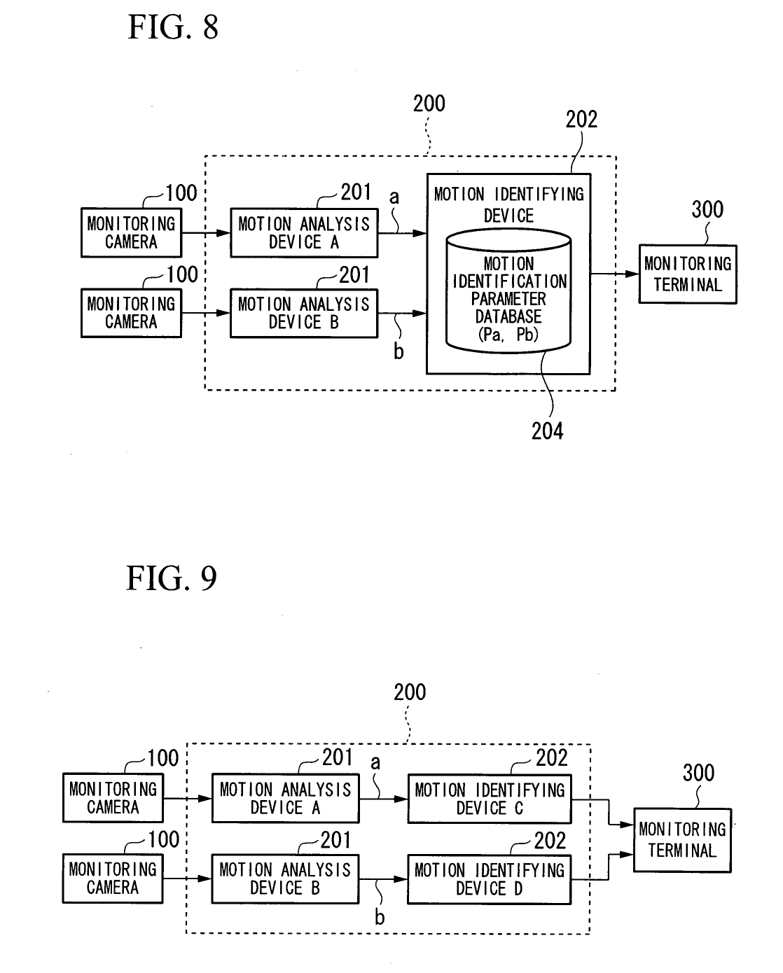

Next, an exemplary arrangement of the case where a single identification result is obtained from a plurality of motion analysis devices 201 will be described with reference to FIG. 8. In this example, time-series data (time-series data a and b) which is an analysis result obtained from a plurality of monitoring cameras 100 and a plurality of motion analysis devices 201 (motion analysis devices A and B) are input to a single motion identification device 202. The motion identification device 202 is prepared with motion identification parameters (motion identification parameters Pa and Pb) for each of the motion analysis devices 201, in its motion identification parameter database 204.

According to the arrangement shown in FIG. 8, it is possible to cope with a situation where the analysis and identification processes cannot be made on the basis of a single image input, thereby enabling identification on the basis of the plurality of image inputs. For example, in a situation where a person is non-visible due to an obstacle, by configuring the monitoring cameras 100 to capture the same person from different angles and allowing the motion analysis device 201 to identify the person, it is possible to decrease dead angles of the system and improve the accuracy of the motion identification. Moreover, even if the motion identification device is connected to an existing motion analysis device, it is possible to generate a complicated motion, improve the elimination rate of false reports, and remove unnecessary information.

Next, an example of the case where different motion analysis devices 201 are used with changes in the motion identification parameter will be described with reference to FIG. 9. In the example shown in FIG. 9, even when specifications such as output formats of the motion analysis device A and the motion analysis device B are different from each other, by modifying the contents of the motion identification parameters stored in the motion identification parameter database 204 in correspondence with the respective output formats and changing respective interfaces between the motion identification devices C and D and the motion analysis devices A and B, it is possible to use the devices in their combined forms. In this case, as long as the time-series data a and b are present, the configurations of the motion identification devices C and D are not particularly limited and may be configured as a software form on a personal computer and a hardware form. According to the arrangement shown in FIG. 9, even if the motion identification device is connected to an existing motion analysis device, it is possible to generate a complicated motion, improve the elimination rate of false reports, and remove unnecessary information.

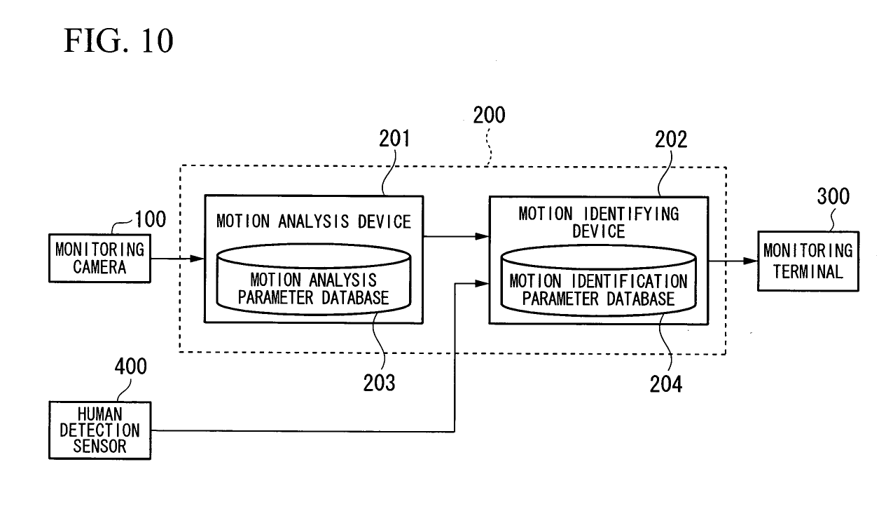

Next, an exemplary arrangement of the image monitoring system using a monitoring camera 100 and a human detection sensor 400 will be described with reference to FIG. 10. In the example shown in FIG. 10, the motion identification device 202 receives time-series data from the motion analysis device 201 and the detection signal (sensor output data) from the human detection sensor 400. In the motion identification parameter database 204, an identification condition corresponding to the sensor output data is prepared in combination with the motion analysis parameter.

According to the arrangement shown in FIG. 10, it is possible to use various kinds of sensor information as well as the image information in the motion identification process. For example, by using infrared-ray sensors or temperature sensors, it is possible to precisely detect the three-dimensional position of subjects for analysis and thus improve the human detection precision. Moreover, even if using the image monitoring system with an existing motion analysis device and an existing sensor, it is possible to generate a complicated motion, improve the elimination rate of false reports, and remove unnecessary information.

As described above, according to the embodiments of the present invention, since the operations of the image monitoring system are divided into two steps, i.e., a motion analysis step and a motion identification step, it is possible to eliminate false reports made by the motion analysis device 201 to provide more advanced behavior analysis. Moreover, it is possible to generate a new motion (a specific purpose motion) using the motion analysis result obtained from the motion analysis device 201. In addition, it is possible to flexibly cope with changes in the system's purpose of use by simply changing the settings of the motion identification device 202. In other words, it is possible to generate and change specific purpose motions in accordance with the system's environment and purpose of use. Accordingly, the adjustment for installing a plurality of systems is made easy, thereby decreasing the number of processes required for the system adjustment. In addition, by installing the motion identification device 202 on an existing system, it is possible to improve the overall performance of the image monitoring system.

Moreover, since the motion identification device that makes a semantic identification using the time-series momentary motion information (the time-series data related to the general purpose motion) is provided on an upper layer of the conventional motion analysis device, it is possible to identify more complicated semantic motions of a person, such as being sick or drunk, through verification of the previous motions detected in a predetermined time. Similarly, it is possible to eliminate false reports made in the motion analysis through verification of its relationship with previous motions, thereby improving the precision of the motion identification. In addition, since the motion analysis deals only with general purpose motion and the motion identification deals with specific purpose motion, it is possible to improve flexibility of the system with respect to the environment.

The embodiments of the present invention are not limited to those described above but may be configured in such a manner that the motion analysis device and the motion identification device are incorporated into a single device and the databases in the devices are integrated into a single database, stored in a remote site or distributed through a communication network. Major functions of the image processing apparatus according to the present invention may be accomplished by allowing a computer to execute a predetermined program. In this case, the program may be recorded to a computer-readable recording medium and then distributed over communication line.

While preferred embodiments of the present invention have been described and illustrated above, it should be understood that these are exemplary of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the appended claims.

What is claimed is:

1. An image processing apparatus comprising:
a motion analysis unit which receives a moving image on a monitoring area captured by an external monitoring camera, analyzes general purpose motion of a person appearing on the monitoring area by performing a predetermined image analysis process on the moving image, and outputs time-series data related to the general purpose motion of the person; and
a motion identification unit which identifies, on the basis of the time-series data related to the general purpose motion of the person, whether or not the general purpose motion corresponds to a specific purpose motion that satisfies a predetermined condition, and outputs motion identification information representing the identification result.

2. The image processing apparatus according to claim 1,
wherein the motion analysis unit includes a first storage unit for storing a motion analysis parameter used for analyzing the general purpose motion of the person, the motion analysis unit analyzing the general purpose motion of the person appearing on the monitoring area on the basis of the motion analysis parameter stored in the first storage unit and the moving image received from the monitoring camera, and
wherein the motion identification unit includes a second storage unit for storing a motion identification parameter used for identifying whether or not the general purpose motion corresponds to the specific purpose motion that satisfies the predetermined condition, the motion identification unit identifying whether or not the general purpose motion corresponds to the specific purpose motion that satisfies the predetermined condition, on the basis of the motion identification parameter stored in the second storage unit and the time-series data related to the general purpose motion of the person.

3. The image processing apparatus according to claim 1,
wherein the motion analysis unit correlates the position of the person, the type of the general purpose motion, and the occurrence time of the general purpose motion with image data including still images of a predetermined number of frames acquired from the moving image and outputs correlated data as the time-series data related to the general purpose motion of the person, and
wherein the motion identification unit outputs the type, duration, and danger level of the specific purpose motion, as the motion identification information.

4. The image processing apparatus according to claim 1, wherein the motion identification unit identifies whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

5. An image processing apparatus comprising: a motion identification unit which identifies, on the basis of time-series data related to a general purpose motion of a person appearing on a predetermined monitoring area, the time-series data being received from the outside, whether or not the general purpose motion corresponds to a specific purpose motion that satisfies a predetermined condition, and outputs motion identification information representing the identification result.

6. The image processing apparatus according to claim 5, wherein the motion identification unit identifies whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

7. A monitoring camera comprising:
an image capturing unit which captures a moving image on a predetermined monitoring area; and
a motion analysis unit which analyzes a general purpose motion of a person appearing on the monitoring area by performing a predetermined image analysis process to the moving image and outputs time-series data related to the general purpose motion of the person.

8. An image monitoring system comprising:
a monitoring camera which captures a moving image on a predetermined monitoring area;
an image processing apparatus including:
a motion analysis unit which receives the moving image on the monitoring area captured by the monitoring camera, analyzes general purpose motion of a person appearing on the monitoring area by performing a predetermined image analysis process on the moving image, and outputs time-series data related to the general purpose motion of the person; and
a motion identification unit which identifies, on the basis of the time-series data related to the general purpose motion of the person, whether or not the general purpose motion corresponds to a specific purpose motion that satisfies a predetermined condition, and outputs motion identification information representing the identification result; and
an informing unit which signals the motion identification information output from the image processing apparatus.

9. The image monitoring system according to claim 8,
wherein the motion analysis unit includes a first storage unit for storing a motion analysis parameter used for analyzing the general purpose motion of the person, the motion analysis unit analyzing the general purpose motion of the person appearing on the monitoring area on the basis of the motion analysis parameter stored in the first storage unit and the moving image received from the monitoring camera, and
wherein the motion identification unit includes a second storage unit for storing a motion identification parameter used for identifying whether or not the general purpose motion corresponds to the specific purpose motion that satisfies the predetermined condition, the motion identification unit identifying whether or not the general purpose motion corresponds to the specific purpose motion that satisfies the predetermined condition, on the basis of the motion identification parameter stored in the second storage unit and the time-series data related to the general purpose motion of the person.

10. The image monitoring system according to claim 8,
wherein the motion analysis unit correlates the position of the person and the type of the general purpose motion, and the occurrence time of the general purpose motion with image data including still images of a predetermined number of frames acquired from the moving image and outputs correlated data as the time-series data related to the general purpose motion of the person, and
wherein the motion identification unit outputs the type, duration, and danger level of the specific purpose motion, as the motion identification information.

11. The image monitoring system according to claim 8, wherein the motion identification unit identifies whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.

12. An image monitoring system comprising:
a monitoring camera which includes:
an image capturing unit capturing a moving image on a predetermined monitoring area; and
a motion analysis unit analyzing general purpose motion of a person appearing on the monitoring area by performing a predetermined image analysis process on the moving image and outputting time-series data related to the general purpose motion of the person;
an image processing apparatus which includes a motion identification unit identifying, on the basis of the time-series data related to the general purpose motion of the person appearing on the predetermined monitoring area, whether or not the general purpose motion corresponds to a specific purpose motion that satisfies a predetermined condition, and outputting motion identification information representing the identification result; and
an informing unit which signals the motion identification information output from the image processing apparatus.

13. The image monitoring system according to claim 12, wherein the motion identification unit identifies whether or not the general purpose motion corresponds to the specific purpose motion that satisfies the predetermined condition, on the basis of the time-series data related to the general purpose motion of the person and a detection signal representing the presence of the person on the monitoring area, the detection signal being received from an external human detection sensor.
